(19) United States
(12) Patent Application Publication
(10) Pub. No.: US 2010/0097280 A1
(43) Pub. Date: Apr. 22, 2010

(54) TRANSPONDER DEVICE

(75) Inventors: Glen Zirbes, Silver Lake, MN (US); Scott Stole, Waconia, MN (US); Martin Kuschewski, Marktoberdorf (DE)

Correspondence Address: SCHWEGMAN, LUNDBERG & WOESSNER, P.A., P.O. BOX 2938, MINNEAPOLIS, MN, 55402, US

(73) Assignee: Smartrac IP B.V., Amsterdam (NL)

(21) Appl. No.: 12/254,685

(22) Filed: Oct. 20, 2008

(51) Int. Cl. H01Q 21/00; H01Q 1/00

(52) U.S. Cl. 343/726; 343/730

(57) ABSTRACT

The present disclosure pertains to a transponder device (10) having an antenna arrangement and a chip (13) disposed on an antenna substrate (11), wherein the antenna arrangement comprises at least a first antenna unit formed as a loop antenna (16) that is connected electrically conductively to contact surfaces (14, 15) of the chip via conductor ends of an antenna conductor (17) that is used for the formation of the loop antenna, and wherein the antenna arrangement besides the first antenna unit comprises at least one further antenna unit formed as a dipole antenna (19).

### FIELD OF THE INVENTION

The present invention pertains to a transponder device having an antenna arrangement and a chip disposed on an antenna substrate, wherein the antenna arrangement includes at least a first antenna unit formed as loop antenna that is connected electrically conductively to contact surfaces of the chip via conductor ends of an antenna conductor that is used for the formation of the loop antenna.

### BACKGROUND

Transponder devices of the aforecited type are known in various embodiments. For instance, transponder devices of this type are designed as a tag to be connected to objects to be marked, or are also employed in card format, for instance embodied as a “chip card”, to be used in authentication systems, particularly in connection with access or use authorizations.

The known transponder devices of the aforecited type are in each embodiment configured to the respectively used frequency range of the data transmission between the chip of the transponder device and a reading device. Thereby, in practice, basically the high frequency range with a standardization of the transmission frequency at 13.56 MHz and the ultra-high frequency range have become widely used. The corresponding transponder devices are hence equipped with a loop antenna or a dipole antenna depending on the frequency range used.

### SUMMARY

Embodiments of the present invention include a transponder device that can be employed both in the high frequency range and in the ultra-high frequency range.

An embodiment of the present invention includes a transponder device having an antenna arrangement and a chip disposed on an antenna substrate, wherein the antenna arrangement comprises at least a first antenna unit formed as loop antenna that is connected electrically conductively to contact surfaces of the chip via conductor ends of an antenna conductor that is used for the formation of the loop antenna.

In the transponder device according to an embodiment of the invention, the antenna arrangement disposed on the antenna substrate, besides the first antenna unit formed as loop antenna, has at least one further antenna unit formed as dipole antenna.

The transponder device according to an embodiment of the invention can hence be employed both in the high frequency range and in the ultra-high frequency range, without the need to provide for a plurality of transponder devices that are each assigned to the various frequency ranges.

If, according to a preferred embodiment, the dipole antenna has two conducting branches that are each formed of an antenna conductor, wherein the ends thereof are connected electrically conductively to contact surfaces of the chip, thus the loop antenna and the dipole antenna as well are connected electrically conductively to contact surfaces of the chip, providing for a data transmission in the ultra-high frequency range between a reading device and the chip, which can be performed directly via the dipole antenna operating in the ultra-high frequency range, without requiring the loop antenna to be used as a signal transmission element. Thus, it is for instance also possible to use the loop antenna in parallel and simultaneously respectively with the dipole antenna for data transmission, such that a transmission of various data in the various frequency ranges can be performed simultaneously.

If the dipole antenna has two conducting branches that are each formed of an antenna conductor, wherein the ends thereof are connected electrically conductively to one another via a connection part, data transmission between the reading device and the chip can be performed via the dipole antenna, whereby an inductive coupling is used between the dipole antenna and the loop antenna.

In an embodiment, the antenna conductor of the first antenna unit and the antenna conductors of the second antenna unit can be connected electrically conductively to one another, such that the dipole antenna is used as a receiving and transmitting antenna and that the loop antenna essentially serves as an electrical conductor for connection to the dipole antenna in a data transmission in the ultra-high frequency range.

An electrically conductive connection of this type between the antenna conductor of the loop antenna and the antenna conductors of the dipole antenna can be realized in an especially advantageous manner via a connection part formed as a joint conductor section of the antenna conductor of the loop antenna and at least one of the antenna conductors of the dipole antenna. Thus, a coherent continuously formed antenna unit can firstly be used as a high frequency antenna and secondly also as an ultra-high frequency antenna, whereby a section of the antenna arrangement serves both for realizing the loop antenna and also for realizing the dipole antenna.

If the dipole antenna with its conducting branches defines an antenna field and the loop antenna is arranged inside of the antenna field, it is possible to use the edges of the antenna substrate over their entire length for forming the conducting branches.

If, according to an embodiment, the dipole antenna with its conducting branches defines an antenna field and the loop antenna is arranged outside of the antenna field, it is possible to use the edges of the antenna substrate over their entire length for forming the loop antenna, such that the circumferential periphery of the surface of the antenna substrate can be advantageously used for providing both a large winding length and a large number of windings respectively.

An embodiment can provide an improvement if the antenna conductor of the loop antenna is arranged on the antenna substrate in such a manner that it defines the circumference of the antenna field and that the dipole antenna is arranged inside of the antenna field.

It can be advantageous in an embodiment, especially for frequency tuning of the dipole antenna, if the antenna conductors of the dipole antenna have varying structural characteristics.

Although the structural characteristics of the dipole antenna and the loop antenna can be identical, in an especially preferred embodiment of the invention, the antenna conductors of the dipole antenna and the antenna conductor of the loop antenna are formed by varying structural characteristics, such that the formation of the respective conductors can be specifically adapted to the space conditions prevailing on the substrate surface of the antenna substrate, or also, to superimpose upon the original antenna functions of the dipole antenna and the loop antenna respectively further functions, for instance mechanical functions. Thus it can be favorable to have the dipole antenna formed by wire being embedded into the surface of the substrate.

For instance it can be advantageous if the loop antenna has a wire conductor mounted onto the surface of the substrate as an antenna conductor—particularly by embedding the wire into the surface of the substrate—and if the dipole antenna has a conductor pattern formed by a metallization of the surface of the substrate as an antenna conductor.

Regardless of the fact that the loop antenna designed as a wire conductor antenna exhibits a particularly high efficiency, the wire conductor besides its antenna function can also fulfil a support function providing mechanical support for the antenna substrate. In addition, a loop antenna formed as a wire conductor also proves to be highly resistant to dynamic alternating stresses that can occur during use of a chip card. Hence, a wire conductor antenna formed for instance circumferentially within the outer periphery can provide stabilizing protection for a dipole antenna formed in the interior of the wire conductor antenna by means of a metallization pattern on the substrate surface.

### BRIEF DESCRIPTION OF DRAWINGS

In the following, embodiments of the transponder device will be described in more detail on the basis of the drawings, whereby

FIG. 1 illustrates a transponder device in a first embodiment;

FIG. 2 illustrates a transponder device in a second embodiment;

FIG. 3 illustrates a transponder device in a third embodiment:

FIG. 4 illustrates a transponder device in a fourth embodiment;

FIG. 5 illustrates a transponder unit in a fifth embodiment;

FIG. 6 illustrates a transponder unit in a sixth embodiment.

### DETAILED DESCRIPTION

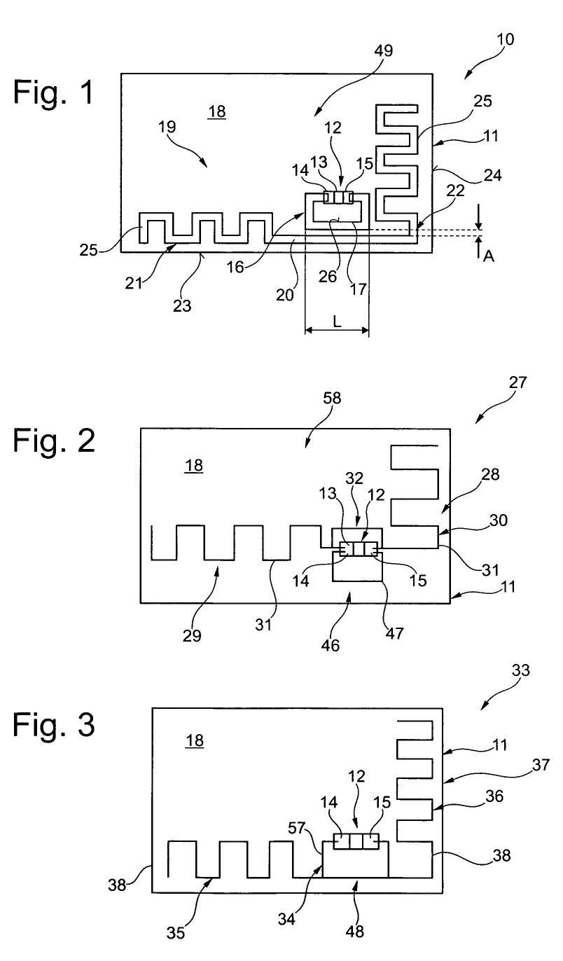

FIG. 1 illustrates a transponder device 10 having a chip module 12 that is arranged on an antenna substrate 11 and that in the present situation comprises a chip 13 that is connected electrically conductively to a loop antenna 16 via chip connection surfaces 14, 15. In case of the exemplary embodiment illustrated in FIG. 1, the loop antenna 16 is formed by an antenna conductor 17 connecting the chip connector areas 14 and 15 of the chip module with one another using the single-winding number.

Apart from the loop antenna 16 there is disposed on a substrate surface 18 of the antenna substrate 11 a dipole antenna 19 having two conducting branches 21 and 22 merging into one another in a connection part 20. The conducting branches 21 and 22 are each formed in a meander-like fashion and extend, inclusive of the connection part 20, along a longitudinal edge 23 and a transversal edge 24 respectively of the antenna substrate 11.

In case of the exemplary embodiment of the transponder device 10 illustrated in FIG. 1, the antenna conductor 17 of the loop antenna 16 and an antenna conductor 25 forming the dipole antenna 19 on the substrate surface 18 are formed identically. Both, the antenna conductor 17 and the antenna conductor 25 are formed by a metallization pattern formed by deposition onto the substrate surface 18. However, it would likewise also be possible to form both the antenna conductor 17 as well as the antenna conductor 25 as a wire conductor which is mounted onto the substrate surface 18 by means of laying.

In the transponder device 10 illustrated in FIG. 1, a coupling section 26 of the loop antenna 16 is arranged essentially in parallel to the connection part 20 of the dipole antenna 19. Thereby, the overlap length L formed between the coupling section 26 and the connection part 20 as well as a coupling distance A formed between the coupling section 26 and the connection part 20 are selected such that a desired inductive coupling between the dipole antenna 19 and the loop antenna 16 is enabled.

As is also apparent from FIG. 1, the dipole antenna 19, with its conducting parts 21, 22 that extend in the illustrated exemplary embodiment along the longitudinal edge 23 and the transversal edge 24 respectively, mounts an antenna field having the loop antenna 16 disposed therein.

FIG. 2 illustrates a transponder device 27 corresponding to the transponder device 10 illustrated in FIG. 1 and having a chip module 12 that is contacted with a loop antenna 46 via chip connection surfaces 14, 15.

Different from the transponder device 10, the transponder device 27 has a dipole antenna 28, wherein the conducting branches 29, 30 thereof are each formed of an antenna conductor 31 that corresponds to an antenna conductor 47 of the loop antenna 46 contacted electrically conductively with the chip connection surfaces 14, 15 of the chip module 12.

In the exemplary embodiment of the transponder device 27 illustrated in FIG. 2, the conducting branches 29, 30 of the dipole antenna 28 are connected to one another via a connection part 32, at the same time connecting electrically conductively the chip connection surfaces 14, 15 to one another. In addition, in the transponder device 27 both the antenna conductor 31 of the dipole antenna 28 and the antenna conductor 47 of the loop antenna 46 are correspondingly formed as wire conductors. Differing therefrom, the antenna conductors can also be formed by a conductor pattern created by metallization of the substrate surface.

In the exemplary embodiment illustrated in FIG. 2, the loop antenna 46 is arranged outside of an antenna field 58 defined by the conducting leads 29, 30 of the dipole antenna 28.

FIG. 3 illustrates a transponder device 33 having a chip module 12 arranged on the substrate surface 18 of the antenna substrate 11, wherein the chip connection surfaces 14, 15 thereof are connected to an antenna conductor 17 forming a loop antenna 34. The loop antenna 34 has a connection part 48 at the same time forming the electrically conductive connection between conducting leads 35, 36 of a dipole antenna 37. In the exemplary embodiment illustrated in FIG. 3, the conducting branches 35, 36 are formed of an antenna conductor 38 formed as a wire conductor on the substrate surface 18 in a meander-like fashion. Diverging from the illustrated embodiment of the transponder device 33, it is also possible to form the antenna conductor 38 forming the conducting branches 35, 36, differing from the antenna conductor 17 formed as a wire conductor of the loop antenna 16, by a conductor pattern formed by metallization of the substrate surface 18.

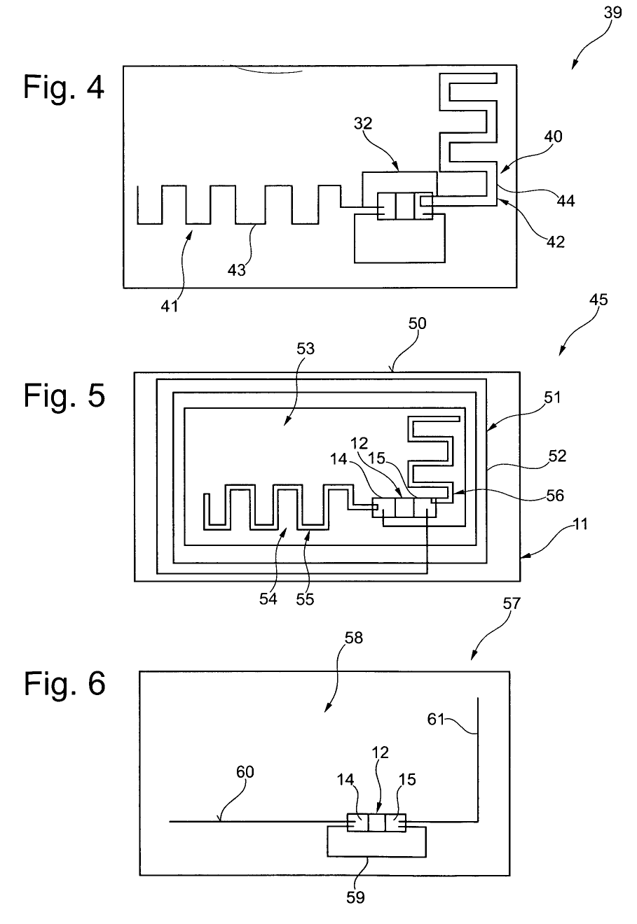

FIG. 4 illustrates a transponder device 39 formed essentially identically to the transponder device 27 illustrated in FIG. 2, differing in that in place of the dipole antenna 28 there is disposed a dipole antenna 40 having conducting branches 41, 42, formed of varying antenna conductors 43, 44. In the situation at hand, the antenna conductor 43 is formed of a wire conductor mounted onto the substrate surface 18 of the antenna substrate 11, and wherein the antenna conductor 44 forming the conducting lead 42 is formed by a conductor pattern formed by deposition of a metallization onto the substrate surface 18. Corresponding to the dipole antenna 28 of the transponder device 27 (FIG. 2), the conducting branches 41, 42 of the dipole antenna 40 are connected to one another via a connection part 32 formed by a wire conductor, as it is the case with the antenna conductor 43.

FIG. 5 illustrates a transponder device 45 having a loop antenna 51 that extends along a peripheral edge 50 of the substrate 11 and that has a plurality of antenna windings that in the present situation are formed of an antenna conductor 52 formed as a wire conductor. In an antenna field 53 defined by the loop antenna 51, there is disposed a dipole antenna 54, wherein the conducting branches 55, 56 thereof just like the conductor ends of the antenna conductor 52 of the loop antenna 51 are connected electrically conductively to the chip connection areas 14, 15 of the chip module 12.

FIG. 6 illustrates a transponder device 57 having a dipole antenna 58 and a loop antenna 59 each being connected electrically conductively to the chip connection areas 14, 15 of the chip module 12. Differing from the transponder device 27 shown in FIG. 2 the dipole antenna 58 exhibits two branches 60, 61 not extending in a serpentine shape but being stretched out straight. The dipole antenna 58 may be formed by embedded wire or by a metallization pattern.

1. A transponder device comprising: an antenna arrangement, an antenna substrate, and a chip disposed on the antenna substrates, wherein the antenna arrangement comprises at least a first antenna unit formed as loop antenna that is connected electrically conductively to contact surfaces of the chip via conductor ends of an antenna conductor that is used for the formation of the loop antenna, wherein the antenna arrangement comprises at least one further antenna unit formed as a dipole antenna.

2. The transponder device according to claim 1, wherein the dipole antenna comprises two conducting branches that are each formed of an antenna conductor, wherein the ends thereof are connected electrically conductively to the contact surfaces of the chip.

3. The transponder device according to claim 2, wherein the dipole antenna comprises two conducting branches that are each formed of an antenna conductor, wherein the ends thereof are connected electrically conductively to one another via a connection part.

4. The transponder device according to claim 3, wherein the antenna conductor of the loop antenna and the antenna conductors of the dipole antenna are connected electrically conductively to one another.

5. The transponder device according to claim 4, wherein the antenna conductor of the loop antenna and the antenna conductors of the dipole antenna are connected electrically conductively to one another via a connection part formed as a joint conductor section of the antenna conductor of the loop antenna and at least one of the antenna conductors of the dipole antenna.

6. The transponder device according to claim 5, wherein the dipole antenna with its conducting branches defines an antenna field and the loop antenna is arranged inside of the antenna field.

7. The transponder device according to claim 5, wherein the dipole antenna with its conducting branches defines an antenna field and the loop antenna is arranged outside of the antenna field.

8. The transponder device according to claim 5, wherein the antenna conductor of the loop antenna defines the circumference of an antenna field and the dipole antenna is arranged inside of the antenna field.

9. The transponder device according to claim 8, wherein the antenna conductors of the dipole antenna have varying structural characteristics.

10. The transponder device according to claim 8, wherein the antenna conductors of the dipole antenna and the antenna conductor of the loop antenna have varying structural characteristics.

11. The transponder device according to claim 10, wherein the loop antenna comprises a wire conductor mounted on the surface of the substrate as an antenna conductor and the dipole antenna comprises a conductor pattern formed by a metallization of the surface of the substrate as an antenna conductor.

12. The transponder device according to claim 1, wherein the dipole antenna comprises two conducting branches that are each formed of an antenna conductor, wherein the ends thereof are connected electrically conductively to one another via a connection part.

13. The transponder device according to claim 12, wherein the antenna conductor of the loop antenna and the antenna conductors of the dipole antenna are connected electrically conductively to one another.

14. The transponder device according to claim 13, wherein the antenna conductor of the loop antenna and the antenna conductors of the dipole antenna are connected electrically conductively to one another via a connection part formed as a joint conductor section of the antenna conductor of the loop antenna and at least one of the antenna conductors of the dipole antenna.

15. The transponder device according to claim 1, wherein the dipole antenna with its conducting branches defines an antenna field and the loop antenna is arranged inside of the antenna field.

16. The transponder device according to claim 1, wherein the dipole antenna with its conducting branches defines an antenna field and the loop antenna is arranged outside of the antenna field.

17. The transponder device according to claim 1, wherein the antenna conductor of the loop antenna defines the circumference of an antenna field and the dipole antenna is arranged inside of the antenna field.

18. The transponder device according to claim 1, wherein the antenna conductors of the dipole antenna have varying structural characteristics.
